(19) United States
(12) Patent Application Publication
(10) Pub. No.: US 2010/0117780 A1
(43) Pub. Date: May 13, 2010

(54) CONDUCTIVE WINDING ASSEMBLY AND FABRICATING METHOD THEREOF

(75) Inventors: Chen-Tsai Hsieh, Taoyuan Hsien (TW); Yung-Yu Chang, Taoyuan Hsien (TW); Ming-Tsung Lee, Taoyuan Hsien (TW); Chen-Yu Yu, Taoyuan Hsien (TW); Nai-Tao Fan, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/563,243

(22) Filed: Sep. 21, 2009

(30) Foreign Application Priority Data
Nov. 11, 2008 (TW) 097143516

(51) Int. Cl. H01F 27/32

(52) U.S. Cl. 336/222; 29/602.1

(57) ABSTRACT

A method for fabricating a conductive winding module of a magnetic element includes the following steps. Firstly, a non-insulated winding structure including multiple conductive units is provided, wherein the conductive units have respective conductive bodies, and one or more of the conductive units have pins. Then, an insulating varnish layer is formed on surfaces of the conductive bodies, thereby producing the conductive winding module.

### FIELD OF THE INVENTION

The present invention relates to a conductive winding module, and more particularly to a slim-type conductive winding module. The present invention also relates to a method for fabricating such a conductive winding module.

### BACKGROUND OF THE INVENTION

Nowadays, magnetic elements such as inductors and transformers are widely used in many electronic devices to generate induced magnetic fluxes. Recently, since the electronic devices are developed toward minimization, the electronic components contained in the electronic products become small in size and light in weight. For example, a flat coil is used as the conductive winding assembly of the magnetic element.

Take a transformer for example. In the transformer, a primary winding coil and a secondary winding coil are wound around a bobbin. Since the bobbin should have a winding section for winding the primary winding coil and the secondary winding coil, the volume of the bobbin is very bulky. For reducing the overall volume of the transformer, the conductive winding module is fabricated by bending multiple copper plates as a multi-loop structure. For isolation, insulating tapes should be previously attached on the surfaces of these copper plates before the bending procedure. As known, the procedure of attaching the insulating tapes is labor-intensive and time-consuming and thus the fabricating cost is increased. Moreover, the thicknesses of the insulating tapes are detrimental to volume reduction of the conductive winding module. If the insulating tapes are scraped off the copper plates, the problem of causing short circuit occurs.

There is a need of providing an improved conductive winding module and the fabricating method thereof in order to obviate the drawbacks encountered from the prior art.

### SUMMARY OF THE INVENTION

It is an object of the present invention to provide a simplified and cost-effective method for fabricating a conductive winding module.

Another object of the present invention provides a conductive winding module with a multi-loop conductive structure in order to reduce the overall volume of the magnetic element.

In accordance with an aspect of the present invention, there is provided a method for fabricating a conductive winding module of a magnetic element. Firstly, a non-insulated winding structure including multiple conductive units is provided, wherein the conductive units have respective conductive bodies, and one or more of the conductive units have pins. Then, an insulating varnish layer is formed on surfaces of the conductive bodies, thereby producing the conductive winding module.

In accordance with another aspect of the present invention, there is provided a conductive winding module of a magnetic element. The conductive winding module includes a non-insulated winding structure and an insulating varnish layer. The non-insulated winding structure includes multiple conductive units. The conductive units have respective conductive bodies, and one or more of the conductive units have pins. The conductive bodies of the non-insulated winding structure are combined together to form an unbroken multi-loop structure. The insulating varnish layer is formed on surfaces of the conductive bodies, wherein the pins are not covered with the insulating varnish layer.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a flowchart illustrating a method for fabricating the conductive winding module of the present invention;

FIG. 2 is a schematic perspective view illustrating a non-insulated winding structure according to a first embodiment of the present invention;

FIG. 3 is a flowchart illustrating the steps of providing the non-insulated winding structure shown in FIG. 2;

FIG. 4 is a schematic exploded view of the non-insulated winding structure shown in FIG. 2;

FIG. 5 is a schematic perspective view illustrating the conductive winding module of the present invention;

FIG. 6 is a schematic exploded view illustrating a transformer having several conductive winding modules of FIG. 5; and

FIG. 7 is a schematic exploded view illustrating an inductor having one conductive winding module of FIG. 5.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention relates to a conductive winding module of a magnetic element. An example of the magnetic element includes but is not limited to an inductor or a transformer.

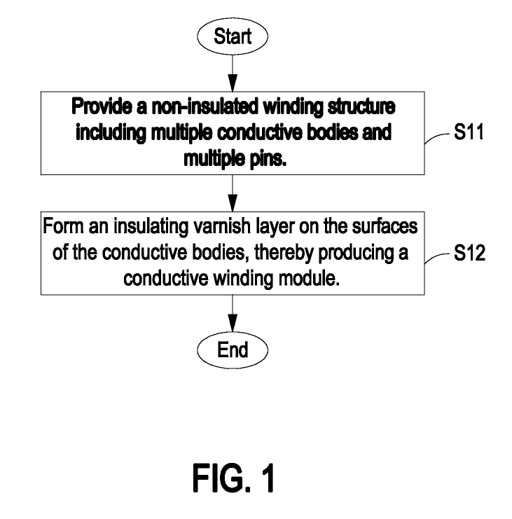

FIG. 1 is a flowchart illustrating a method for fabricating the conductive winding module of the present invention. First of all, a non-insulated winding structure is provided (S11). The non-insulated winding structure includes multiple conductive units with multiple conductive bodies and multiple pins. Next, an insulating varnish layer is formed on the surfaces of the conductive bodies, thereby producing the conductive winding module of the present invention (S12).

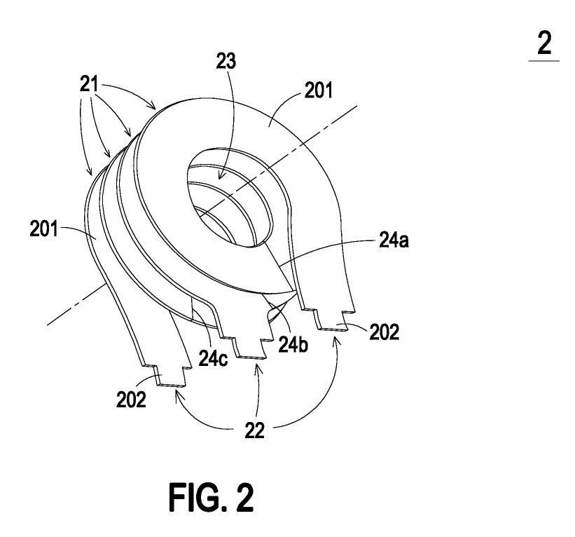

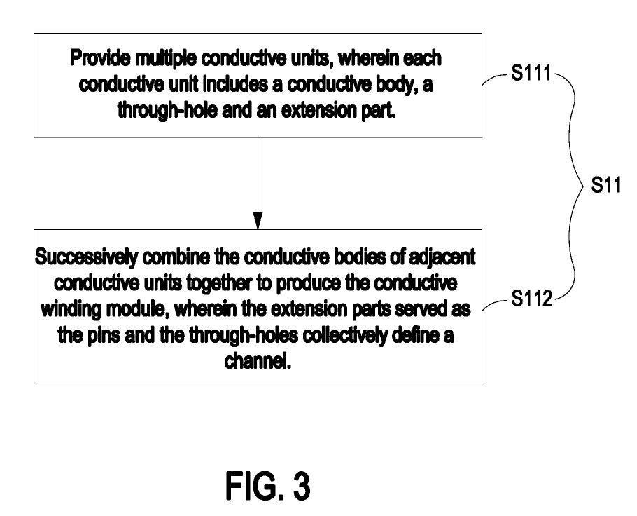

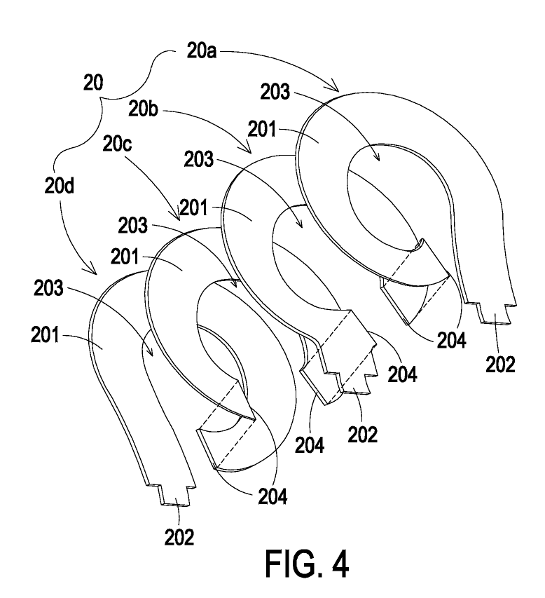

FIG. 2 is a schematic perspective view illustrating a non-insulated winding structure according to a first embodiment of the present invention. FIG. 3 is a flowchart illustrating the steps of providing the non-insulated winding structure shown in FIG. 2. FIG. 4 is a schematic exploded view of the non-insulated winding structure shown in FIG. 2. Please refer to FIGS. 2, 3 and 4. The non-insulated winding structure 2 includes multiple conductive units 20, which are combined together by a high-temperature welding process. In this embodiment, four conductive units 20a, 20b, 20c and 20d are included in the non-insulated winding structure 2 for illustration. Each of these four conductive units 20a, 20b, 20c and 20d is a single conductive plate made of metallic material such as copper. It is preferred that these conductive plates have the same thickness. Each of the conductive units 20a, 20b, 20c and 20d includes a conductive body 201. The shape of the conductive body 201 is varied according to the practical requirements. In this embodiment, the conductive body 201 is ring-shaped and has a central through-hole 203. The non-insulated winding structure 2 further has several extension parts 202, which are extended from the peripheries of some or all of the conductive units 20a, 20b, 20c and 20d. As shown in FIG. 4, three extension parts 202 are respectively extended from the peripheries of the first conductive unit 20a, the second conductive unit 20b and the fourth conductive unit 20d.

For assembling these four conductive units 20, the conductive bodies 201 of adjacent conductive units 20 are successively combined together by a high-temperature welding process, wherein the through-holes 203 are aligned with each other. For example, the fourth conductive unit 20d and the third conductive unit 20c are simultaneously supported by a jig tool (not shown), wherein the through-holes 203 of the fourth conductive unit 20d and the third conductive unit 20c are aligned with each other and the welding ends 204 of the fourth conductive unit 20d and the third conductive unit 20c are contacted with each other. Next, by a high-temperature welding process, these two neighboring welding ends 204 are molten and then solidified as a joining seam 24c (see FIG. 2). The joining seam 24c is a welding seam resulted from the high-temperature welding process. As a result, the conductive bodies 201 of the fourth conductive unit 20d and the third conductive unit 20c are smoothly connected with each other. Similarly, the welding ends 204 of the third conductive unit 20c and the second conductive unit 20b are molten and then solidified as a joining seam 24b by a high-temperature welding process, so that the conductive bodies 201 of the third conductive unit 20c and the second conductive unit 20b are smoothly connected with each other. Similarly, the welding ends 204 of the second conductive unit 20b and the first conductive unit 20a are molten and then solidified as a joining seam 24a by a high-temperature welding process, so that the conductive bodies 201 of the second conductive unit 20b and the first conductive unit 20a are smoothly connected with each other.

After the fourth conductive units 20 are connected with each other, the non-insulated winding structure 2 of the present invention is assembled. The resulting configurations of the non-insulated winding structure 2 are shown in FIG. 2. Meanwhile, the extension parts 202 are served as the pins 22 and the through-holes 203 of these fourth conductive units 20 collectively define a channel 23. Since three extension parts 202 are respectively extended from the peripheries of the first conductive unit 20a, the second conductive unit 20b and the fourth conductive unit 20d, the non-insulated winding structure 2 has only three pins 22. In other words, the non-insulated winding structure 2 is an unbroken four-loop structure with three pins in a staggered arrangement.

The number of the conductive units 20 and the number the pins 22 may be varied according to the practical requirements. In addition, the sequence of welding the conductive bodies 201 of neighboring conductive units 20 may be varied according to the practical requirements.

An example of the high-temperature welding process includes but is not limited to a laser welding process, an electron beam welding process or a plasma welding process. In some embodiments, the welding ends of the conductive units are optionally subject to a black treatment in order to reduce the reflectivity of the metallic plates. Due to the reduced reflectivity, the welding energy is concentrated and the joining seams 24a, 24b and 24c have smooth appearance.

In some embodiments, the non-insulated winding structure 2 is formed in a mold (not shown) by an electroforming process. Under this circumstance, the non-insulated winding structure 2 is an integral structure.

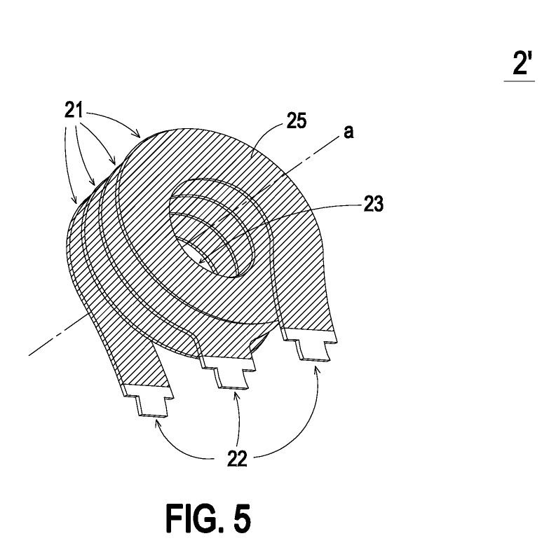

After the non-insulated winding structure 2 is provided, an insulating varnish layer 25 is formed on the surfaces of the conductive bodies 21, thereby producing the conductive winding module 2′ as shown in FIG. 5. The procedure of forming an insulating varnish layer on the surfaces of the conductive bodies includes for example a powder coating process, a spray coating process or a dipping process.

For carrying out the powder coating process, the non-insulated winding structure 2 is firstly placed on a coating chamber (not shown). Then, insulating varnish powder (e.g. epoxy resin powder) is negatively charged to be uniformly adsorbed on the surface of the non-insulated winding structure 2. Then, a baking step is performed to melt the insulating varnish powder. After the molten insulating varnish powder is cooled, the insulating varnish layer 25 is formed on the surfaces of the conductive bodies 21. The insulating varnish layer 25 offers an insulating efficacy so as to prevent the short-circuit problem.

For carrying out the dipping process, the conductive bodies 21 of the non-insulated winding structure 2 are immersed in a vessel filled with an insulating varnish solution. After a certain dipping period, the insulating varnish layer 25 is formed on the surfaces of the conductive bodies 21. The insulating varnish solution includes for example melamine/alkyd impregnating varnish, epoxy resin dipping varnish or alkyd amino impregnating varnish.

For carrying out the spray coating process, polyurethane insulating varnish solution is sprayed onto the surfaces of the conductive bodies 21 by a spray gun, thereby forming the insulating varnish layer 25. It is of course that the materials for forming the insulating varnish layer 25 are varied according to the practical requirements.

Please refer to FIG. 5 again. After the magnetic element having the conductive winding module 2′ is fabricated, the pins 22 could be soldered onto corresponding contact pads or conductive holes of a system circuit board (not shown), so that the magnetic element is electrically connected with the system circuit board via the pins 22. For marking electrical connection between the magnetic element and the system circuit board, the pins 22 are not covered with the insulating varnish layer 25. For example, before the process of forming the insulating varnish layer 25 on the surfaces of the conductive bodies 21, the pins 22 need to be previously covered with other insulating material. Alternatively, the insulating varnish layer 25 may be simultaneously formed on the surfaces of the conductive bodies 21 and the pins 22, but the insulating varnish layer 25 covering the pins 22 need to be removed later. In other words, the pins 22 should keep electrically conductive but the surfaces of the conductive bodies 21 should be insulated from each other. Since the conductive bodies 21 and the pins 22 are conductive and thin and the insulating varnish layer 25 is substantially a thin film, the conductive winding module 2′ can be referred as a flat-type conductive winding module.

Please refer to FIG. 5 again. In a case that the conductive winding module 2′ is compressed along the axel direction “a”, the gap between every two adjacent conductive bodies 21 of the conductive winding module 2′ is reduced. As such, the conductive winding module 2′ can be applied to a magnetic element such as a transformer or an inductor.

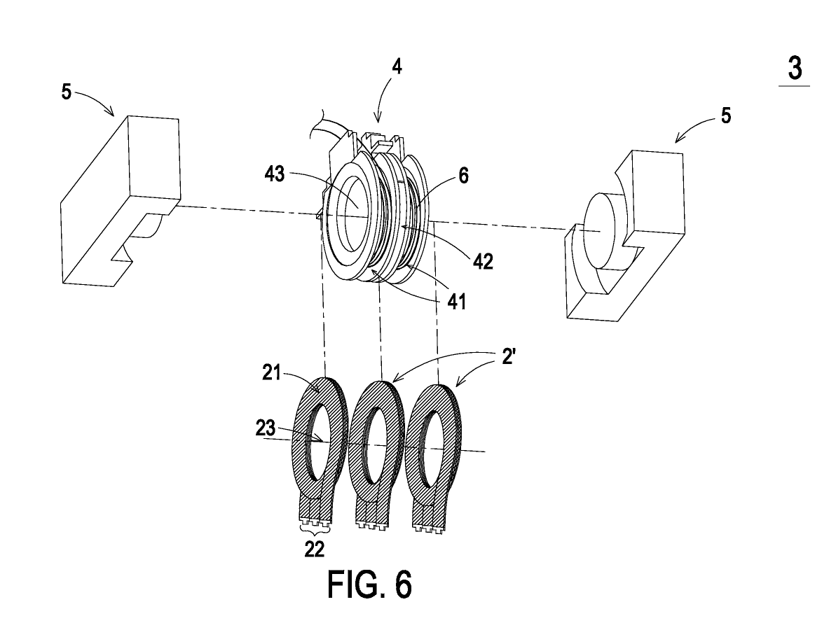

FIG. 6 is a schematic exploded view illustrating a transformer having several conductive winding modules of FIG. 5. As shown in FIG. 6, the transformer 3 principally includes a bobbin 4, a magnetic core assembly 5 and several conductive winding modules 2′. The bobbin 4 includes a winding section 41, a receiving part 42 and a hollow portion 43 running through the bobbin 4. The cross-sectional profile of the bobbin 4 is similar to that of the conductive body 21 of the conductive winding module 2′. A primary winding assembly 6 is wound around the winding section 41 of the bobbin 4. The conductive bodies 21 of two conductive winding modules 2′ are attached on bilateral sides of the bobbin 4, and the conductive bodies 21 of one conductive winding module 2′ is accommodated within the receiving part 42. These conductive winding modules 2′ are used as the secondary winding assemblies of the transformer 3. When the conductive winding modules 2′ are combined with the bobbin 4, the channels 23 of the conductive winding modules 2′ are aligned with the hollow portion 43 of the bobbin 4. The magnetic core assembly 5 is partially embedded into the hollow portion 43 of the bobbin 4 and the channels 23 of the conductive winding modules 2′. When the pins 22 pins are soldered onto corresponding contact pads or conductive holes of a system circuit board (not shown), the transformer 3 is electrically connected with the system circuit board. As a result, the primary winding assembly 6 and the secondary winding assemblies (i.e. the conductive winding modules 2′) interact with the magnetic core assembly 5 to achieve the purpose of voltage regulation. Since the secondary winding assemblies are flat-type conductive winding modules 2′, the overall thickness of the transformer 3 is reduced.

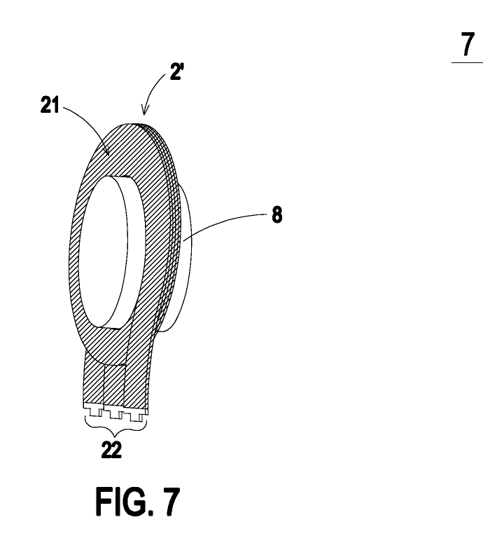

FIG. 7 is a schematic exploded view illustrating an inductor having one conductive winding module of FIG. 5. As shown in FIG. 8, the inductor 7 includes a conductive winding module 2′ and a magnetic core assembly 8. The magnetic core assembly 8 is penetrated through the channel 23 of the conductive winding module 2′ such that the magnetic core assembly 8 is sheathed by the conductive winding module 2′. When the pins 22 are soldered onto corresponding contact pads or conductive holes of a system circuit board (not shown), the inductor 7 is electrically connected with the system circuit board.

From the above embodiments, it is noted that the non-insulated winding structure may be produced according to diverse processes. For example, as shown in FIGS. 2 and 4, the conductive bodies of the non-insulated winding structure are combined together by a high-temperature welding process. Alternatively, the non-insulated winding structure is formed in a mold by an electroforming process as an integral structure, so that no welding seams are created. Alternatively, the non-insulated winding structure is fabricated by bending multiple copper plates as a multi-loop structure. For marking electrical connection between the magnetic element and the system circuit board, the pins are not covered with the insulating varnish layer. In a case that the non-insulated winding structure is fabricated by bending multiple copper plates, the insulating varnish layer may be previously formed on the whole flat metallic plate before the bending process. Since the non-insulated winding structure produced by the high-temperature welding process, the electroforming process or the bending process is very thin and the insulating varnish layer is relatively thinner than the insulating tape, the overall thickness of the magnetic element is reduced.

In the above embodiments, the insulating varnish layer is formed on the surfaces of the conductive bodies 21 by a mechanical process such as a powder coating process, a spray coating process or a dipping process. The mechanical process is very convenient and time-saving in comparison with the conventional method of attaching the insulating tapes. Moreover, since the insulating varnish layer is not easily scraped off the surfaces of the conductive bodies, the short-circuit problem is avoided.

From the above description, the method for fabricating the conductive winding module of the present invention includes a step of forming the insulating varnish layer on the conductive bodies after the non-insulated winding structure is provided. In comparison with the prior art wherein the insulating tapes are previously attached on the conductive bodies, the fabricating method of the present invention is simplified and cost-effective. Moreover, since the insulating varnish layer is substantially a thin film, the overall thickness of the conductive winding module of the present invention is reduced while maintaining a good electrical safety.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for fabricating a conductive winding module of a magnetic element, said method comprising steps of:
providing a non-insulated winding structure including multiple conductive units, wherein said conductive units have respective conductive bodies, and one or more of said conductive units have pins; and
forming an insulating varnish layer on surfaces of said conductive bodies, thereby producing said conductive winding module.

2. The method according to claim 1 wherein said insulating varnish layer is formed on said surfaces of the conductive bodies by a powder coating process.

3. The method according to claim 1 wherein said insulating varnish layer is formed on said surfaces of the conductive bodies by a spray coating process.

4. The method according to claim 1 wherein said insulating varnish layer is formed on said surfaces of the conductive bodies by a dipping process.

5. The method according to claim 1 wherein said conductive bodies of said non-insulated winding structure are combined together by a high-temperature welding process, thereby forming an unbroken multi-loop structure.

6. The method according to claim 5 wherein said high-temperature welding process is a laser welding process.

7. The method according to claim 5 wherein said conductive bodies of said conductive units are conductive plates made of metallic material.

8. The method according to claim 1 wherein said conductive bodies of said conductive units have respective through-holes collectively defining a channel, and said magnetic element further includes a magnetic core assembly, which is partially embedded into said channel.

9. The method according to claim 1 wherein said conductive winding module is slim-type conductive winding module.

10. A conductive winding module of a magnetic element, said conductive winding module comprising:
a non-insulated winding structure including multiple conductive units, wherein said conductive units have respective conductive bodies, one or more of said conductive units have pins, and said conductive bodies of said non-insulated winding structure are combined together to form an unbroken multi-loop structure; and
an insulating varnish layer formed on surfaces of said conductive bodies, wherein said pins are not covered with said insulating varnish layer.

11. The conductive winding module according to claim 10 wherein said conductive bodies of said non-insulated winding structure are combined together by a high-temperature welding process.

12. The conductive winding module according to claim 10 wherein said conductive bodies of said conductive units are conductive plates made of metallic material.

13. The conductive winding module according to claim 10 wherein said conductive bodies of said conductive units have respective through-holes collectively defining a channel.

14. The conductive winding module according to claim 13 wherein said magnetic element further includes a magnetic core assembly, which is partially embedded into said channel.

15. The conductive winding module according to claim 10 wherein said conductive winding module is slim-type conductive winding module.

16. The conductive winding module according to claim 10 wherein said magnetic element is a transformer or an inductor.
